(19) United States
(12) Patent Application Publication
(10) Pub. No.: US 2005/0108706 A1
(43) Pub. Date: May 19, 2005

(54) Method and system for dynamically loading server code on a client to support multiple veresions of client and servers in a client/server application

(75) Inventor: Brian S. McCain, Tucson, AZ (US)

Correspondence Address: Scully, Scott, Murphy & Presser, 400 Garden City Plaza, Garden City, NY, 11530, US

(73) Assignee: International Business Machines Corporation, Armonk, NY (US)

(21) Appl. No.: 10/714,303

(22) Filed: Nov. 14, 2003

(51) Int. Cl. G06F 9/445

(52) U.S. Cl. 717/177

(57) ABSTRACT

A client host obtains software by establishing a session with a server host, and downloading software from the first server host for use during the session to implement a client side of a particular version of a network application. The software is compatible with software executed at the server host to implement a server side of the network application. Moreover, the client host may establish sessions at the same time with other server hosts by downloading software from the other server hosts for running a different version of the same application, or a different application. The client host may also establish multiple sessions with the same server host to run different applications. In an analogous procedure, a server hosts downloads software from one or more client hosts.

### BACKGROUND OF THE INVENTION

1. Field of the Invention

The invention relates generally to the field of computer systems and, more specifically, to a technique for maintaining software version compatibility between a client host and a server host.

2. Description of the Related Art

In a client/server application, a client side of the application is executed on a client host, and a server side of the application is executed on a server host. Typically, the appropriate code/software can be downloaded from a remote source or installed locally from a storage media such as a CD-ROM. From time to time, new versions of the software are developed, such as to provide new features or to accommodate hardware changes at the hosts. Thus, a situation arises where a client and server are running different versions of the application software. Even if the host that is running the later software version is backward compatible with the earlier software version, the features of the later software version cannot be employed. Moreover, such backward compatibility is not always assured.

Accordingly, updates to the client or the server software often result in incompatibilities between versions of client and server code. This forces a user of the application to install more code than they want or need simply to use the new features. For example, a client that wishes to communicate with a first server that is running a version 1.0 of an application software, as well as a second server that is running a version 2.0 of the application software, would need to have both versions of the corresponding client side software installed to maintain compatibility with both servers. This requires additional expense and computing resources.

Another solution is to limit the functionality between different versions of client and server code, or to require the server to be updated with the latest version of code so the server can “know” about all previous client code levels and adjust itself to communicate with them. Other solutions require the client to obtain and store the new version of the client code from the server when a version difference is detected. This keeps the client up-to-date with the server with which it is communicating, but it causes problems if the client needs to communicate with a different server that is using a different version of code. This solution also requires the client to restart before the new version can be used, which can be disruptive in certain applications.

### BRIEF SUMMARY OF THE INVENTION

To overcome these and other deficiencies in the prior art, the present invention provides a technique for maintaining software version compatibility between a client host and a server host.

In a particular aspect of the invention, a method for use by a client host in obtaining software includes establishing a session with a first server host, and downloading first software from the first server host for use during the session to implement a client side of a first version of a first network application. The first software is compatible with software executed at the first server host to implement a server side of the first version of the first network application. Moreover, the client host may establish sessions at the same time with other server hosts by downloading software from the other server hosts for running a different version of the same application that is run with the first host, or a different application. The client host may also establish multiple sessions with the same server host to run different applications.

In another aspect, a method for use by a server host in obtaining software includes participating in a session established by a first client host, and downloading first software from the first client host for use during the session to implement a server side of a first version of a first network application. The first software is compatible with software executed at the first client host to implement a client side of the first version of the first network application.

A related host computer system and program storage device are also provided.

### BRIEF DESCRIPTION OF THE DRAWINGS

These and other features, benefits and advantages of the present invention will become apparent by reference to the following text and figures, with like reference numbers referring to like structures across the views, wherein:

FIG. 1 illustrates a computer system including a client host and multiple server hosts;

FIG. 2 illustrates software being downloaded by a client host from multiple server hosts; and

FIG. 3 illustrates a method for maintaining software version compatibility between a client host and one or more server hosts.

### DETAILED DESCRIPTION OF THE INVENTION

This invention solves the problem of maintaining software version compatibility between client and server hosts by dynamically downloading client code from the server to the client, as the client needs it. The client itself, as it is initially installed, does not have any functionality for implementing an application. Instead, it dynamically loads code from the server when it needs it to perform some function, e.g., by running a network application. For example, a client host may desire to store data at a server host that comprises a storage subsystem. In this case, the client will implement an application that allows the client host to perform functions for storing data. The functions may include requesting that the server host stores data, and may specify further details such as type of storage, storage location, and the like. Since the code for running the application is coming from the server, the client will always be up-to-date and won't have compatibility issues. That is, the client will run a client-side version of the application software that is compatible with the server-side version of the application software that is run by the server. If the client then communicates with a different server that is using a different version of the application software, or running a different application altogether, the client will load the appropriate code from each server, thereby allowing the client to communicate with different servers. The advantage of this invention over other solutions is that it allows different levels of clients and servers to communicate without requiring any action by the user to update the code or restarting the application to upgrade it.

In one approach, the client is designed as a skeleton, containing only the necessary information to connect to a server and to download and use client code from the server. As the client does its work, it determines if it has the necessary information to continue. If it needs additional code, it requests it from the server at the time it is needed. The client then uses that code to interact with the server. This guarantees that the client will always be able to communicate with the server and always can use all the features the server supports. A further advantage is that, since code is downloaded from the server only when it is needed, the client is more efficient and processing and storage resources are saved. The invention can be implemented using various software coding techniques. For example, an object-oriented software such as Java™ may be used. Java code provides specialized class loaders, also referred to as user-defined or custom class loaders, which can be used to dynamically download and use the software from the server as objects on an as needed basis. For example, assume a client needs a class named CommandA to execute some function on the server. The client would use a specialized class loader to look for the class CommandA in local memory. If the class CommandA cannot be found in local memory, the specialized class loader would request the class CommandA to be downloaded from the server into local memory. The client could then use the class CommandA to continue with its execution. In addition, a class named CommandB may also be available on the server for the client to use. However, if the client never determines the need for the class CommandB, CommandB will not be downloaded into local memory on the client.

Moreover, if the client needs to connect to multiple servers, each connection can contain its own version of the code for the server to which it is connected. This allows the client to communicate simultaneously with different servers, even if they are running different versions of the same network application and/or different network applications, without having any versioning issues. In this environment, multiple specialized class loaders would be employed, each responsible for downloading code from a particular server. When the client knows that it needs to be working with a particular server, it would go to the specialized class loader for that server in order to find the code needed to do its work.

The same principal can be applied to the server instead of the client. The difference would be that, once connected, the client sends its version of the server code to the server. The server then uses that code to interact with the particular client. This guarantees that a server is able to support all the features of any given client, regardless of the version of the server. The server could also support multiple client connections in the same way by receiving the server-side code from each client and only using it for communicating with the client from which the code was received. The above concepts are further illustrated below.

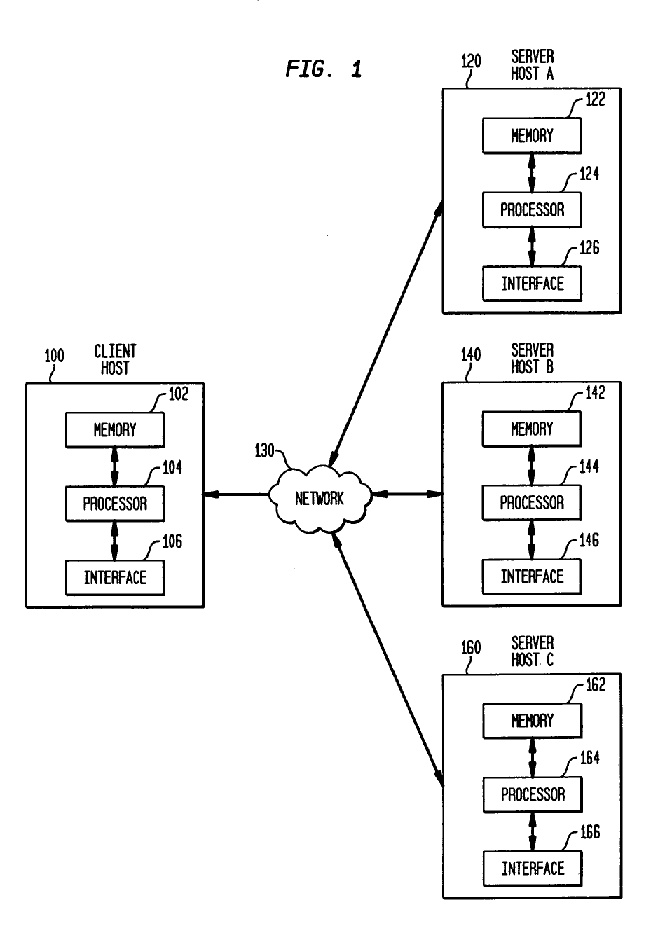

FIG. 1 illustrates a computer system including a client host and multiple server hosts. The client host 100 includes a memory 102, processor 104 and network interface 106. The network interface 106 allows the client host 100 to communicate with a number of different server hosts, such as server host A (120), server host B (140), and server host C (160) via a network 130 such as the Internet. The server host A (120) includes a memory 122, processor 124 and network interface 126, while the server host B (140) includes a memory 142, processor 144 and network interface 146, and the server host C (160) includes a memory 162, processor 164 and network interface 166. The general operation and configuration of the memories 102, 122, 142 and 162, processors 104, 124, 144 and 164, and network interfaces 106, 126, 146 and 166, is well known in the art and is therefore not described in detail. The components illustrated are provided to assist in understanding the invention. The hosts 100, 120, 140 and 160 may be general-purpose computers, workstations, servers, portable devices such as PDAs, or other computer devices.

The functionality described herein can be achieved by configuring the hosts 100, 120, 140 and 160 with appropriate software. In one approach, the software comprises an object-oriented software such as Java code that is stored in the memories 100, 122, 142 and 162 of the client host 100, and server hosts 120, 140 and 160, respectively. The memories may therefore be considered program storage devices for carrying out a method for achieving the functionality described herein. The software is executed using the processors 104, 124, 144 and 164.

Initially, before a session is established between the client host 100 and any of the server hosts 120, 140 and 160, the server hosts 120, 140 and 160 store software for implementing both the client-side and server-side of an application in their respective memories 122, 142 and 162. At this time, the client host 100 does not store software for implementing the client-side of an application in its memory 102. After a session is established with one or more servers, the client host 100 downloads and executes the appropriate client-side software for implementing a network application with the corresponding server. Multiple versions of the same application can be implemented at the same time with different servers. Moreover, multiple different applications can be implemented at the same time with the same server and/or different servers.

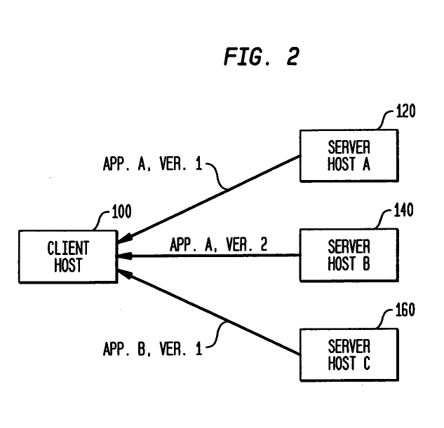

FIG. 2 illustrates software being downloaded by a client host from multiple server hosts. The client host 100 downloads software from the server hosts 120, 140 and 160 after establishing respective sessions with them. The invention can thus be implemented using one or more sessions that the client establishes with one or more server hosts. Moreover, multiple sessions with the same server host can be used, e.g., to run different applications. Note that the above comments can be applied to the case where a server host communicates with one or more client hosts when sessions are established. In this case, the server participates in a session that is established or initiated by the client.

In the present example, the client host 100 establishes a session with server A (120) to implement a first version of a first application, e.g., app. A, ver. 1. The client host 100 also establishes a session with server B (140) to implement a second version of the first application, e.g., app. A, ver. 2. For example, the second version may be an updated version of the first application that provides additional features relative to the first version. Thirdly, the client host 100 establishes a session with server C (160) to implement a first version of a second application, e.g., app. B, ver. 1. The second application is different from the first application. Each of the sessions can overlap, at least partly, in time, or can occur at non-overlapping times.

When the client host 100 downloads software from one or more server hosts, it places the software in memory, so once the client stops running, the code is gone. The client need not actually store the code it receives from the server, so the code does not have to be deleted when no longer needed, e.g., after the session terminates. However, it is possible for the client host to store the downloaded code, e.g., to use the same code the next time it connects to the server from which the code was downloaded. This avoids the need to download the code again. The client could compare the version of the code it has locally with the version the server has in order to determine if the local version is sufficient or if the version at the server must be retrieved. Moreover, the client may implement a timer for deleting stored code after a certain amount of time. The timer can be set by the client or by the server.

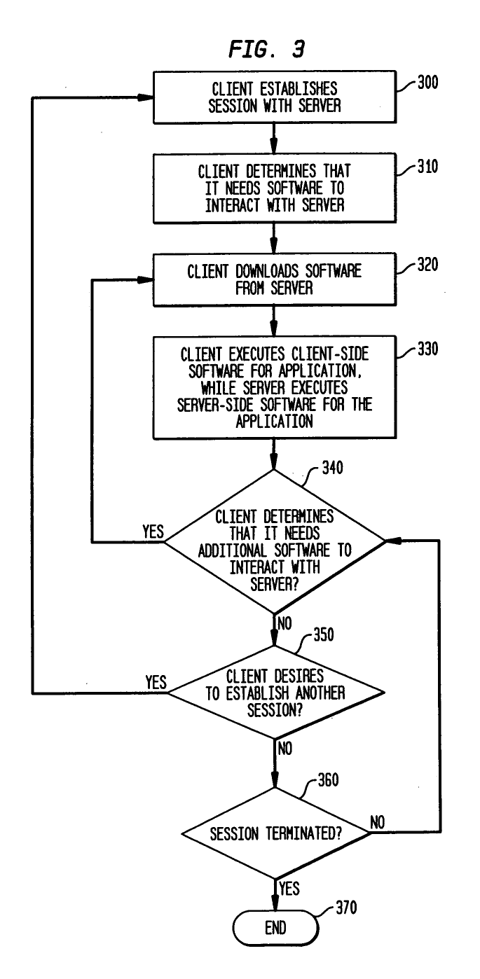

FIG. 3 illustrates a method for maintaining software version compatibility between a client host and one or more server hosts. At block 300, the client establishes a session with a server. At block 310, the client determines that it needs software to interact with the server. For example, this can be achieved by using specialized class loaders. The client would request specific code from the specialized class loader. The specialized class loader would then determine if that code exists in local memory. If it does exist, it returns that code to the client. If it does not exist, the specialized class loader will then download the appropriate code from the server, store it in local memory, then return it to the client. At block 320, the client downloads the necessary software from the server. At block 330, the client executes the downloaded software to implement the client side of an application. The server executes corresponding server-side software to implement the application. At block 340, the client determines whether it needs additional software to interact with the server. For example, the client may need additional software when different functionality is required by the user of the application. For example, the user of the application could initially be requesting information from the server. As the user requests information, the client would only need to download code from the server that concerns requesting information from the server. Later, the user may decide to modify some of the information stored on the server. At that point, the client would need to download code from the server that concerns modifying information on the server. If it does, it downloads and executes the software as discussed at block 320 and 330, respectively.

At block 350, the client determines if it needs to establish another session, e.g., with another server or the same server. For example, a client may need to establish session with different servers when different servers provide different sets of data that the client needs. For example, Server A could contain all the data regarding a company's West coast sales, while Server B could contain all the data regarding a company's East coast sales. If the client were trying to combine the data in some way, it would need to connect to each server to retrieve those data. If an additional session is needed, the client establishes the session and downloads and executes the appropriate client-side code as discussed in connection with blocks 300, 310, 320 and 340. The method may end (block 370) when the session terminates (block 360).

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

1. A method for use by a client host in obtaining software, comprising:
establishing a session with a first server host; and
downloading first software from the first server host for use during the session to implement a client side of a first version of a first network application;
wherein the first software is compatible with software executed at the first server host to implement a server side of the first version of the first network application.

2. The method of claim 1, wherein:
the downloading comprises downloading the first software from the first server host dynamically, as needed, by the client host.

3. The method of claim 1, wherein:
the client host initiates the downloading when it determines that it needs the first software to interact with the first server host.

4. The method of claim 1, wherein:
the downloading comprises downloading the first software as at least one object using at least one specialized class loader.

5. The method of claim 1, further comprising:
establishing a session with a second server host; and
downloading second software from the second server host for use during the session therewith to implement a client side of a second version of the first network application that differs from the first version;
wherein the second software is compatible with software executed at the second server host to implement a server side of the second version of the first network application.

6. The method of claim 5, wherein:
the sessions with the first and second server hosts overlap, at least in part.

7. The method of claim 1, further comprising:
establishing a session with a second server host;
downloading second software from the second server host for use during the session therewith to implement a client side of a second network application that differs from the first network application;
wherein the second software is compatible with software executed at the second server host to implement a server side of the second network application.

8. The method of claim 1, further comprising:
establishing a further session with the first server host;
downloading second software from the first server host for use during the further session to implement a client side of a second network application that differs from the first network application; wherein:
the second software is compatible with software executed at the first server host to implement a server side of the second network application; and
the session and further session with the first server host overlap, at least in part.

9. A program storage device, tangibly embodying a program of instructions executable by a client host to obtain software, the method comprising:
establishing a session with a first server host; and
downloading first software from the first server host for use during the session to implement a client side of a first version of a first network application;
wherein the first software is compatible with software executed at the first server host to implement a server side of the first version of the first network application.

10. The program storage device of claim 9, wherein:
the downloading comprises downloading the first software from the first server host dynamically, as needed, by the client host.

11. The program storage device of claim 9, wherein:
the client host initiates the downloading when it determines that it needs the first software to interact with the first server host.

12. The program storage device of claim 9, wherein:
the downloading comprises downloading the first software as at least one object using at least one specialized class loader.

13. The program storage device of claim 9, wherein the method further comprises:
establishing a session with a second server host; and
downloading second software from the second server host for use during the session therewith to implement a client side of a second version of the first network application that differs from the first version;
wherein the second software is compatible with software executed at the second server host to implement a server side of the second version of the first network application.

14. The program storage device of claim 13, wherein:
the sessions with the first and second server hosts overlap, at least in part.

15. A method for use by a server host in obtaining software, comprising:
participating in a session established by a first client host; and
downloading first software from the first client host for use during the session to implement a server side of a first version of a first network application;
wherein the first software is compatible with software executed at the first client host to implement a client side of the first version of the first network application.

16. The method of claim 15, wherein:
the downloading comprises downloading the first software from the first client host dynamically, as needed, by the server host.

17. The method of claim 15, wherein:
the server host initiates the downloading when it determines that it needs the first software to interact with the first client host.

18. The method of claim 15, wherein:
the downloading comprises downloading the first software as at least one object using at least one specialized class loader.

19. The method of claim 15, further comprising:
participating in a session established by a second client host; and
downloading second software from the second client host for use during the session therewith to implement a server side of a second version of the first network application that differs from the first version;
wherein the second software is compatible with software executed at the second client host to implement a client side of the second version of the first network application.

20. The method of claim 19, wherein:
the sessions with the first and second client hosts overlap, at least in part.
